(19) United States
(12) Patent Application Publication
(10) Pub. No.: US 2006/0287215 A1
(43) Pub. Date: Dec. 21, 2006

(54) Color-changing composition comprising a thermochromic ingredient

(76) Inventors: J. Gavin McDonald, Decatur, GA (US); Brendon F. Ribble, Menasha, WI (US); Kelly D. Arehart, Roswell, GA (US)

Correspondence Address: KIMBERLY-CLARK WORLDWIDE, INC., 401 NORTH LAKE STREET, NEENAH, WI, 54956, US

(21) Appl. No.: 11/155,353

(22) Filed: Jun. 17, 2005

(51) Int. Cl. C11D 17/00

(52) U.S. Cl. 510/441

(57) ABSTRACT

Disclosed is a cleaning composition comprising a thermochromic ingredient that effects a color change at a given temperature or temperature range. Such a composition may be used to provide a signal, i.e., convey information, to a user of the cleaning composition, or a caregiver employing the cleaning composition. Additionally, the cleaning composition may be employed in a substrate, such as a nonwoven. The cleaning compositions may be used to provide a signal that helps improve cleaning effectiveness and/or safety and/or entertainment value. Furthermore, compositions comprising one or more thermochromic ingredients may be used to signify, or help induce, a given mental state, psychological state, or state of well being.

### BACKGROUND

People rely on personal care or cleaning formulations, shampoos, lotions, body washes, hand sanitizers, bar soaps, etc., whether in the form of a solid, liquid, gel, paste, foam, or the like, as part of their everyday lives for hygiene and health benefits.

Often such products can be more effective if used for a specific or minimum amount of time. For example, a number of organizations (e.g., the U.S. Centers for Disease Control and Prevention, or “CDC”) recommend that a person wash his or her hands for a specific length of time to help remove or destroy bacteria. (See Background section of U.S. 2005/0049157 A1, entitled “Single Phase Color Change Agents” to MacDonald et al. for additional information; this application is incorporated by reference in its entirety in a manner consistent herewith.)

Also, the use of such products by children can be promoted or encouraged, thereby leading to training, by associating a “play” or “entertainment” element to use of the product. (Id.)

Furthermore, such products are often used in combination with water or other liquids. While adult users of such products can sense whether water is not at an appropriate temperature (e.g., too hot), such perceptions may not reflect recommended temperatures for personal cleaning. That is, an adult might prefer to use such products at a temperature that is higher that that which is recommended generally. Also, adult caregivers may not be able to perceive the temperature of water or other liquids with reasonable accuracy. Accordingly, such caregivers may inadvertently select a liquid temperature (e.g., the temperature of bath water for an infant) that is higher than that which is generally recommended for infants.

In some instances, personal-care items like those identified above can help create an association in the mind of a user between the item, or use thereof, and a given mental state, psychological state, or state of well being (e.g., a state of peace, spirituality, energy, sensuality, relaxation, etc.). Such association can be facilitated by color, fragrance, and/or marketing copy or statements pointing out such association to a user or potential user of the personal-care item.

Also, today's users of personal-care, household-cleaning, and other such products want and expect convenience. Accordingly, articles of manufacture that are perceived as delivering convenience are generally preferred by consumers. One manner by which personal-care, household-cleaning, and other such products can be made convenient is by providing a composition on a disposable substrate. A user can use the disposable substrate for its intended purpose, such as cleaning or washing, and then dispose of the substrate.

What is needed is an article of manufacture and method to help make various personal-care or cleaning compositions more effective, safe, enjoyable, and/or satisfying to use.

### SUMMARY

We have determined that thermo-chromic materials, i.e., materials that change color in response to the transport of energy to the material, may be used in cleaning or other personal-care compositions to convey information to a user, caregiver, or sensor. One way by which energy may be transported to a thermo-chromic material or ingredient is by heat transfer. I.e., when the thermo-chromic material or ingredient, which is at a given temperature, is brought into contact with a liquid or other material at a different temperature, energy, in the form of heat energy, is transported to or from the thermo-chromic material or ingredient. If, for example, the thermo-chromic ingredient is in a liquid soap at room temperature, and the liquid soap is brought into contact with water at a higher temperature, then heat energy will be systematically transferred from the heated water to the thermo-chromic ingredient. If the thermo-chromic ingredient is selected such that its color changes at a temperature between that of room temperature and the temperature of the heated water, then the liquid soap will be perceived or detected as changing color when the temperature of the thermo-chromic ingredient reaches that of the selected temperature. Of course the time at which this temperature is reached depends on the rate at which heat energy is transferred from the heated water to the liquid soap comprising the thermo-chromic ingredient. Accordingly, the color change can convey several kinds of information to the user, caregiver, or sensor, including, for example: (1) that the temperature at which the thermo-chromic ingredient changes color has been reached; (2) that the temperature of a material with which the thermo-chromic ingredient, or a composition employing the thermo-chromic ingredient, has been brought into contact is at a given temperature or temperature range; (3) that the time of contact between the thermo-chromic ingredient, or a composition employing the thermo-chromic ingredient, and another material is of a given duration; and the like.

Thus use of a personal-care or cleaning composition comprising one or more thermochromic ingredients, and therefore adapted to effect one or more color changes, may be used for each of the contexts described in the Background section above. Specifically, such compositions or formulations may be used to facilitate the effectiveness (e.g., providing a signal through a color change that the cleaning formulation has been used for a given duration),.safety (e.g., providing a signal through a color change that the water temperature with which the formulation is being used is safe for the user), entertainment (e.g., change colors in a pleasing or enjoyable way), and/or association between the mind of a user and a given mental state, psychological state, or state of well being (e.g., providing a signal through a color change that may be associated with states of well being, such as, for example, a state of peace, spirituality, energy, etc.). These and other versions of the invention are described more fully below.

### DRAWINGS

FIG. 1 representatively illustrates a cleaning composition, in this case a bar of soap, comprising one or more thermochromic ingredients and a novelty item, such that the bar, when placed in warm water, effects a color change from a colored state to a colorless state, thereby revealing the novelty item.

FIG. 2 representatively illustrates a cleaning composition, in this case a shaped bar of soap, comprising one or more thermochromic ingredients placed in a patterned fashion on and/or in said bar, such that the bar, when placed in warm water, effects a plurality of color changes, and optionally reveals a novelty item.

### DEFINITIONS

Within the context of this specification, each term or phrase below includes the following meaning or meanings:

“Attach” and its derivatives refer to the joining, adhering, connecting, bonding, sewing together, depositing on, associating with, or the like, of two elements. Two elements will be considered to be attached together when they are integral with one another or attached directly to one another or indirectly to one another, such as when each is directly attached to intermediate elements. “Attach” and its derivatives include permanent, releasable, or refastenable attachment. In addition, the attachment can be completed either during the manufacturing process or by the end user.

“Bond” and its derivatives refer to the joining, adhering, connecting, attaching, sewing together, or the like, of two elements. Two elements will be considered to be bonded together when they are bonded directly to one another or indirectly to one another, such as when each is directly bonded to intermediate elements. “Bond” and its derivatives include permanent, releasable, or refastenable bonding.

“Coform” refers to a blend of meltblown fibers and absorbent fibers such as cellulosic fibers that can be formed by air forming a meltblown polymer material while simultaneously blowing air-suspended fibers into the stream of meltblown fibers. The coform material may also include other materials, such as superabsorbent materials. The meltblown fibers and absorbent fibers are collected on a forming surface, such as provided by a foraminous belt. The forming surface may include a gas-pervious material that has been placed onto the forming surface.

“Cleaning composition”, “cleaning formulation,” or their derivatives refer to personal care or cleaning formulations or compositions, shampoos, lotions, body washes, hand sanitizers, bar soaps, etc., whether in the form of a solid, liquid, gel, paste, foam, or the like.

“Connect” and its derivatives refer to the joining, adhering, bonding, attaching, sewing together, or the like, of two elements. Two elements will be considered to be connected together when they are connected directly to one another or indirectly to one another, such as when each is directly connected to intermediate elements. “Connect” and its derivatives include permanent, releasable, or refastenable connection. In addition, the connecting can be completed either during the manufacturing process or by the end user.

“Disposable” refers to articles which are designed to be discarded after a limited use rather than being laundered or otherwise restored for reuse.

The terms “disposed on,” “disposed along,” “disposed with,” or “disposed toward” and variations thereof are intended to mean that one element can be integral with another element, or that one element can be a separate structure bonded to or placed with or placed near another element.

“Fiber” refers to a continuous or discontinuous member having a high ratio of length to diameter or width. Thus, a fiber may be a filament, a thread, a strand, a yarn, or any other member or combination of these members.

“Hydrophilic” describes fibers or the surfaces of fibers which are wetted by aqueous liquids in contact with the fibers. The degree of wetting of the materials can, in turn, be described in terms of the contact angles and the surface tensions of the liquids and materials involved. Equipment and techniques suitable for measuring the wettability of particular fiber materials or blends of fiber materials can be provided by a Cahn SFA-222 Surface Force Analyzer System, or a substantially equivalent system. When measured with this system, fibers having contact angles less than 90 degrees are designated “wettable” or hydrophilic, and fibers having contact angles greater than 90 degrees are designated “nonwettable” or hydrophobic.

“Layer” when used in the singular can have the dual meaning of a single element or a plurality of elements.

“Liquid impermeable,” when used in describing a layer or multi-layer laminate means that liquid, such as urine, will not pass through the layer or laminate, under ordinary use conditions, in a direction generally perpendicular to the plane of the layer or laminate at the point of liquid contact.

“Liquid permeable” refers to any material that is not liquid impermeable.

“Meltblown” refers to fibers formed by extruding a molten thermoplastic material through a plurality of fine, usually circular, die capillaries as molten threads or filaments into converging high velocity gas (e.g., air) streams, generally heated, which attenuate the filaments of molten thermoplastic material to reduce their diameters. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblowing processes can be used to make fibers of various dimensions, including macrofibers (with average diameters from about 40 to about 100 microns), textile-type fibers (with average diameters between about 10 and 40 microns), and microfibers (with average diameters less than about 10 microns). Meltblowing processes are particularly suited to making microfibers, including ultra-fine microfibers (with an average diameter of about 3 microns or less). A description of an exemplary process of making ultra-fine microfibers may be found in, for example, U.S. Pat. No. 5,213,881 to Timmons, et al. Meltblown fibers may be continuous or discontinuous and are generally self bonding when deposited onto a collecting surface.

“Member” when used in the singular can have the dual meaning of a single element or a plurality of elements.

“Nonwoven” and “nonwoven web” refer to materials and webs of material that are formed without the aid of a textile weaving or knitting process. For example, nonwoven materials, fabrics or webs have been formed from many processes such as, for example, meltblowing processes, spunbonding processes, air laying processes, and bonded carded web processes.

“Sensor” refers to a device capable of detecting a change in color by optical (e.g., absorbance, transmittance, and the like) or other such means.

“Thermo-chromic” or “thermochromic” refers to materials or ingredients that undergo a temperature-induced color change.

These terms may be defined with additional language in the remaining portions of the specification.

### DESCRIPTION

Representative Thermo-Chromic Ingredients and Chemistries

Thermo-chromic materials and ingredients are discussed in the literature. (See, e.g., U.S. Pat. No. 5,741,592, entitled “Microencapsulated System for Thermal Paper,” to Maurice W. Lewis, et al., which is hereby incorporated by reference. in its entirety in a manner consistent herewith; U.S. Pat. No. 4,028,118, entitled “Thermochromic Materials,” to Norikazu Nakasuji, which is hereby incorporated by reference in its entirety in a manner consistent herewith; Mary Anne White and Monique LeBlanc, “Thermochromism in Commercial Products,” 76 Journal of Chemical Education No. 9, at pp. 1201-1204 (September 1999); Gary D. White, Debora A. Zartman, and Judith M. Bonicamp, “A Serious Look at Changeable Silly Putty,” 5 Chem. Educator No. 1, at pp. 2-7 (2000). Generally such materials and ingredients change color in response to changes in temperature. Categories of such materials and ingredients include, for example, leuco dyes, available from Color Change Corporation, a company having offices in Streamwood, Ill.; leuco dyes available from Chromatic Technologies Incorporated, a business having offices in Colorado Springs, Colo.; and liquid crystals, available from Hallcrest, Inc., a business having offices in Glenview, Ill. These materials change color at specific temperatures or temperature ranges. The materials may be combined such that multiple color changes may be obtained as the temperature changes. For example, a thermo-chromic ingredient that undergoes a color change from 23 to 26 degrees Celsius might be combined with a second thermo-chromic ingredient that undergoes a color change from 29 to 31 degrees Celsius. As the combination is heated from about 20 degrees Celsius to about 35 degrees Celsius, it would proceed through two color changes. Another version includes a mixture of two thermochromic dyes having different colors and different transition temperature. For example, one thermochromic ingredient may be selected that is red, initially, and then changes to a colorless liquid at, for example, 29 degrees Celsius. A second thermochromic ingredient may be selected that is green, initially, and then changes to a colorless liquid at, for example, 33 degrees Celsius. The combination of these two ingredients is brown, initially. When this combination is warmed, the red thermochromic component is rendered colorless when the temperature is proximate to 29 degrees Celsius, with the combination turning green (i.e., the color of the thermochromic ingredient that has not yet changed color). Additional warming of the combination will change the green thermochromic component to a colorless state, thereby rendering the combination colorless (or having a white appearance if the combination, alone or as employed in a personal-care or cleaning composition, produces foam).

Alternatively, two or more thermo-chromic ingredients could be combined which undergo a color change at approximately the same temperature range. For example, two thermo-chromic ingredients could be selected that each undergo a color change at a temperature of 23 to 26 degrees Celsius. Furthermore, each of the thermo-chromic ingredients may effect a different change of color at the selected temperature range. Depending on how the thermo-chromic ingredients are combined, the combination could effect a color change different than that produced by each of the thermo-chromic materials alone. For example, if thermo-chromic ingredient A underwent a color change from colorless to yellow at a temperature range of 23 to 26 degrees Celsius, and thermo-chromic ingredient B underwent a color change from colorless to blue at a temperature range of 23 to 26 degrees Celsius, then, depending on how the two ingredients were combined (i.e., blended to form an essentially uniform or homogenous material; or patterned, for example, as in a layered combination), the resulting color change perceived by a human eye might be from colorless to green (i.e., the combination blue and yellow).

As noted above, one or more thermochromic ingredients may effect a color change from a specific color to a colorless state (or white appearance if, for example, foam is present) as the temperature changes. Or one or more thermochromic ingredients may effect a color change from a colorless state to a color. By using a plurality of thermochromic ingredients, the combination can be used to effect multiple color changes. Also, any of the representative versions may optionally include one or more pigments or colored materials that do not change color as temperature changes. By adding such optional pigments the color of the solution or composition employing one or more thermochromic ingredients can be further manipulated. For example, if a thermochromic ingredient normally proceeded from blue to a colorless appearance as the temperature is increased, and a substantially non-color-changing yellow pigment was added to said thermochromic ingredient (or a composition or solution employing said ingredient), then the combination would proceed from green (the combination of blue and yellow colors) to yellow as temperature is increased.

Of course, the preceding paragraphs give examples of the ways by which a thermo-chromic ingredient may be used alone or in combination with one or more other thermo-chromic ingredients. The identified temperature ranges are exemplary both at the endpoints of the ranges (e.g., 23 to 26 degrees Celsius) and in the breadth of the ranges (e.g., 3 degrees Celsius). Other ranges may be selected. Other endpoints and ranges are possible and compatible with the present invention.

As stated above, thermo-chromic ingredients may be selected such that the ingredient changes from one color to another; from a colorless appearance to a color; or from a color to a colorless appearance. Also, a plurality of thermochromic ingredients (plus any optional materials or ingredients, such as a substantially non-color-changing pigment or pigments) may be used to achieve a plurality of color changes as temperature changes.

Thermochromic ingredients may be employed in personal-care or cleaning compositions in various ways. For example, the category of thermo-chromic materials available from Color Change Corporation are organic dyes (e.g., leuco dyes), may be microencapsulated, as described below, and employed in a personal-care or cleaning composition, with the composition optionally associated with a substrate. Generally, such thermo-chromic systems include at least two chemical components: usually a leuco dye and a color developer. The leuco dye changes from color to clear (no color) upon heating. They are weak organic bases, and become colored in solution when in their protonated form (generally with the proton being donated by a color developer, e.g., a weak acid). Generally these materials change from colored to colorless over a 5 to 15 degree Fahrenheit interval (with changing temperature shifting the equilibrium between the protonated and unprotonated form of the leuco dye).

Examples of leuco dyes include spirolactones such as fluorans or crystal violet lactone, spiropyrans, fulgides, and the like. As noted above, color developers are weak acids (i.e., proton donors or electron acceptors). Examples of such components include bisphenol A, octyl p-hydroxybenzoate, methyl p-hydroxybenzoate, 1,2,3-triazoles, 4-hydroxycoumarin derivatives, and the like. A third component for an organic-dye system (such as a leuco dye) is generally a polar solvent such as an alcohol, ester, ketone, or ether. Examples include lauryl alcohol (i.e., 1-dodecanol), cetyl alcohol (i.e., 1-hexadecanol), and butyl stearate.

Another category of materials are liquid crystals, such as those available from Hallcrest, Inc. These thermo-chromic materials tend to change color over a sharper, more precise temperature range compared to leuco dyes. Examples of such materials include cholesteryl esters, cyano-biphenyls, and the like.

Leuco dyes and liquid crystals are two examples of thermo-chromic ingredients that may be used in different versions and embodiments of the present invention(s). Any thermo-chromic material may be used, so long as the material changes color at a given temperature, or over a given temperature range. Thermo-chromic materials can be employed in products in different forms. For example, such materials may be microencapsulated, either alone, or in combination with other thermo-chromic materials, permanent pigments, or other additives. Microencapsulation serves a variety of purposes, including, for example, containing the dye, color developer, and temperature-responsive esters and alcohols in close proximity to each other; and protecting the microencapsulated materials from air and/or ultraviolet radiation and/or other environmental factors.

A thermo-chromic ingredient can be combined with other ingredients in a microcapsule. So, for example, a leuco dye could be combined with a color developer (i.e., a material that will facilitate protonation of the leuco dye) in a suitable solvent. This combination of materials could be combined with methyl stearate in a melamine formaldehyde microcapsule. Methyl stearate, a lipid, is opaque when solid but is transparent when a liquid. Accordingly, at a higher temperature, the methyl stearate is a transparent liquid, the leuco dye and color developer dissolve, thereby disfavoring protonation of the leuco dye (i.e., disfavoring the mechanism by which a color change is effected from a colorless material to a colored material). At lower temperatures, methyl stearate solidifies, the leuco dye and the color developer are frozen out, thereby facilitating protonation of the dye and the color becomes visible. So, with this system, the thermo-chromic ingredient goes from a color to being colorless. (See Gary D. White, Debora A. Zartman, and Judith M. Bonicamp, “A Serious Look at Changeable Silly Putty,” 5 Chem. Educator No. 1, at pp. 5-6 (2000)).

As described in the Examples section below, the following microencapsulated thermochromic dyes were used to prepare representative versions of the present invention.

Table 1 presents examples of microencapsulated, leuco dyes obtained from Color Change Corporation. These thermochromic ingredients effect a reversible color change (i.e., the color change effected by an increase in temperature is reversed when the temperature is decreased). The table identifies the initial color of the thermochromic ingredient (under the caption “Cold Color”), the color of the thermochromic ingredient effected by a sufficient increase in temperature (under the caption “Warm Color”), and the temperature, in degrees Celsius, at which the color change occurs (under the caption “Transition Temp”).

TABLE 1
Leuco Dye Powder (LD-P), Microencapsulated,
from Color Change Corp.

| Cold Color | Warm Color | Transition Temp (° C.) |
|---|---|---|
| Red | Colorless | 29 |
| Red | Colorless | 31 |
| Red | Colorless | 33 |
| Yellow | Colorless | 31 |
| Black | Colorless | 31 |
| Black | Colorless | 33 |
| Black | Colorless | 43 |
| Blue | Colorless | 29 |
| Blue | Colorless | 31 |
| Blue | Colorless | 33 |

Tables 2 and 3 present examples of microencapsulated, leuco dyes obtained from Chromatic Technologies Incorporated. The identified thermochromic materials, like those identified above, effect a reversible color change. The table identifies the initial color of the thermochromic ingredient (under the caption “Cold Color”), the color of the thermochromic ingredient effected by a sufficient increase in temperature (under the caption “Warm Color”), and the temperature, in degrees Celsius, at which the color change occurs (under the caption “Transition Temp”).

TABLE 2
Dynacolor (reversible color change) from Chromatic Technol. Inc.

| Cold Color | Warm Color | Transition Temp (° C.) |
|---|---|---|
| Purple | Pink | 40 |
| Magenta | colorless | 31 |

TABLE 3
Leuco Dye as encapsulated dye in water slurry (50% solids, reversible
color change) from Chromatic Technol. Inc.

| Cold Color | Warm Color | Transition Temperature (° C.) |
|---|---|---|
| Blue | Colorless | 29 |
| Blue | Colorless | 32 |
| Blue | Colorless | 35 |

Representative Compositions Employing One or More Thermochromic Ingredients

A number of different compositions, such as cleaning compositions, can employ one or more thermo-chromic ingredients such that a color change, or changes, occur during use of the composition. As stated above, such changes provide a signal to a user, caregiver, or sensor (e.g., an optical sensor capable of detecting absorbance of a liquid; if the color in the liquid changes, then the sensor would detect the change in absorbance). Accordingly, the color change can convey or signify several kinds of information to the user, caregiver, or sensor, including, for example: (1) that the temperature at which the thermo-chromic ingredient changes color has been reached; (2) that the temperature of a material with which the thermo-chromic ingredient, or a composition employing the thermo-chromic ingredient, has been brought into contact is at a given temperature or temperature range; (3) that the time of contact between the thermo-chromic ingredient, or a composition employing the thermo-chromic ingredient, and another material is of a given duration; and the like.

Cleaning compositions of the present invention include toiletries such as, but not limited to, soaps (liquid and bar), skin lotions, colognes, sunscreens, shampoos, gels, toothpastes, mouthwashes, bodywashes, and the like. Such compositions may be in solid, liquid, gel, foam, or other forms.

Cleaning compositions further include but are not limited to products such as hard surface cleansers and medical disinfectants. Hard surface cleansers incorporating thermo-chromic ingredients may be used in the home or business environment in, for example, food preparation areas. For example, a cleaning composition comprising one or more thermochromic ingredients may be applied in a warm state such that the ingredient, or ingredients, are colorless. During cleaning, and with the passage of time, the temperature of the cleaning composition returns to ambient temperature, thereby effecting a color change that signifies to the user that cleaning and/or disinfecting and/or other action is complete and rinsing may occur.

In another version of the invention, an alcohol suspension may be applied at ambient temperature and the evaporation of the alcohol cools the surface developing the color. In such uses, the time from application to color change may be adjusted to provide effective microbial elimination or reduction. Likewise, medical disinfectants using thermo-chromic ingredients can let a user know when a time sufficient for effective microbial control has elapsed.

Many toiletries and cleaners contain similar core ingredients; such as water and surfactants. They may also contain oils, detergents, emulsifiers, film formers, waxes, perfumes, preservatives, emollients, solvents, thickeners, humectants, chelating agents, stabilizers, pH adjusters, and so forth. In U.S. Pat. No. 3,658,985, for example, an anionic based composition contains a minor amount of a fatty acid alkanolamide. U.S. Pat. No. 3,769,398 discloses a betaine-based composition containing minor amounts of nonionic surfactants. U.S. Pat. No. 4,329,335 also discloses a composition containing a betaine surfactant as the major ingredient and minor amounts of a nonionic surfactant and of a fatty acid mono- or di-ethanolamide. U.S. Pat. No. 4, 259,204 discloses a composition comprising 0.8 to 20% by weight of an anionic phosphoric acid ester and one additional surfactant which may be either anionic, amphitricha, or nonionic. U.S. Pat. No. 4,329,334 discloses an anionic amphoteric based composition containing a major amount of anionic surfactant and lesser amounts of a betaine and nonionic surfactants.

U.S. Pat. No. 3,935,129 discloses a liquid cleaning composition containing an alkali metal silicate, urea, glycerin, triethanolamine, an anionic detergent and a nonionic detergent. The silicate content determines the amount of anionic and/or nonionic detergent in the liquid cleaning composition. U.S. Pat. No. 4,129,515 discloses a liquid detergent comprising a mixture of substantially equal amounts of anionic and nonionic surfactants, alkanolamines and magnesium salts, and, optionally, zwitterionic surfactants as suds modifiers. U.S. Pat. No. 4,224,195 discloses an aqueous detergent composition comprising a specific group of nonionic detergents, namely, an ethylene oxide of a secondary alcohol, a specific group of anionic detergents, namely, a sulfuric ester salt of an ethylene oxide adduct of a secondary alcohol, and an amphoteric surfactant which may be a betaine, wherein either the anionic or nonionic surfactant may be the major ingredient. Detergent compositions containing all nonionic surfactants are shown in U.S. Pat. Nos. 4,154,706 and 4,329,336. U.S. Pat. No. 4,013,787 discloses a piperazine based polymer in conditioning and shampoo compositions. U.S. Pat. No. 4,450,091 discloses high viscosity compositions containing a blend of an amphoteric betaine surfactant, a polyoxybutylenepolyoxyethylene nonionic detergent, an anionic surfactant, a fatty acid alkanolamide and a polyoxyalkylene glycol fatty ester. U.S. Pat. No. 4,595,526 describes a composition comprising a nonionic surfactant, a betaine surfactant, an anionic surfactant and a C12-C14 fatty acid mono-ethanolamide foam stabilizer. The contents of the patents discussed herein are hereby incorporated by reference as if set forth in their entirety and in a manner consistent herewith.

Further information on these ingredients may be obtained, for example, by reference to: Cosmetics & Toiletries, Vol.102, No.3, March 1987; Balsam, M. S., et al., editors, Cosmetics Science and Technology, 2nd edition, Vol. 1, pp 27-104 and 179-222 Wiley-Interscience, New York, 1972, Vol. 104, pp 67-111, February 1989; Cosmetics & Toiletries, Vol. 103, No.12, pp 100-129, December 1988, Nikitakis, J. M., editor, CTFA Cosmetic Ingredient Handbook, first edition, published by The Cosmetic, Toiletry and Fragrance Association, Inc., Washing-ton, D.C., 1988, Mukhtar, H, editor, Pharmacology of the Skin, CRC Press 1992; and Green, F J, The Sigma-Aldrich Handbook of Stains. Dyes and Indicators; Aldrich Chemical Company, Milwaukee Wis., 1991, the contents of which are hereby incorporated by reference as if set forth in their entirety and in a manner consistent herewith.

Exemplary materials that may be used in the practice of this invention further include but are not limited to those discussed in Cosmetic and Toiletry Formulations by Ernest W. Flick, ISBN 0-8155-1218-X, second edition, section XII (pages 707-744).

These include, but are not limited to for example, the following formulations:

TABLE 4
Representative Formulations That may be Adapted to Include One or
More Thermochromic Ingredients.

| | wt % |
|---|---|
| Liquid hand soap | |
| EMERY 5310 coconut sulfosuccinate | 20 |
| EMERSAL 6400 sodium lauryl sulfate | 10 |
| EMID 6513 lauramide DEA | 3 |
| EMID 6540 linoleamide DEA | 2 |
| ETHOXYOL 1707 emulsifying acetate ester | 1 |
| EMERSOL 233 oleic acid | 1 |
| EMERESSENCE 1160 rose ether phenoxyethanol | 1 |
| Triethanolamine | 0.5 |
| Deionized water | balance |
| Liquid soap | |
| Ammonium laureth sulfate, 60% | 24 |
| Cocamidopropyl betaine | 6 |
| Stearamidopropyl dimethylamine | 1.5 |
| Sodium chloride | 1.3 |
| Glycol distearate | 1 |
| Citric acid | 0.25 |
| Methylparaben | 0.15 |
| Propylparaben | 0.05 |
| Bronopol | 0.05 |
| Water | balance |
| Bar soap | |
| Soap base 80/20 | 95.68 |
| Water | 1 |
| Antioxidant | 0.07 |
| Perfume oil | 0.75 |
| Titanium dioxide | 0.5 |
| GLUCAM E-20 | 2 |

Representative Substrates Employing a Composition that Includes One or More Thermochromic Ingredients

A number of different substrates may be used with compositions of the present invention. As noted above, present-day consumers look for convenience in their products. One way of meeting this need is by incorporating various compositions in a substrate, likely a disposable substrate. Accordingly, the present invention encompasses a number of versions and embodiments in which a cleaning composition comprising one or more thermo-chromic ingredients is deposited on or attached to a substrate.

Examples of substrates compatible with the present invention include webs comprising porous foams, reticulated foams, apertured plastic films, natural fibers (for example, wood or cotton fibers), synthetic fibers (for example, polyester or polypropylene fibers), or a combination of natural and synthetic fibers. The substrate can also be made from extensible materials as are described in U.S. Pat. No. 6,552,245 issued on Apr. 22, 2003 to Roessler et al. Alternatively, the substrate can also be made from biaxially stretchable materials as are described in U.S. patent application Ser. No. 09/698,517 filed on Oct. 27, 2000 by Vukos et al.

Various woven and nonwoven fabrics can be used for the substrate. For example, the substrate may be composed of a meltblown or spunbond web of polyolefin fibers. The substrate may also be a bonded-carded web composed of natural and/or synthetic fibers. The substrate may be composed of a substantially hydrophobic material, and the hydrophobic material may optionally be treated with a surfactant or otherwise processed to impart a desired level of wettability and hydrophilicity. In one embodiment, the substrate is made from a nonwoven, spunbond, polypropylene fabric composed of fibers having a fiber diameter of about 21 to 23 microns formed into a web having a basis weight of about 20 grams per square meter and a density of about 0.13 grams per cubic centimeter. The fabric may be surface treated with about 0.3 weight percent of a surfactant, such as a surfactant commercially available from Hodgson Textile Chemicals, Inc. under the trade designation AHCOVEL Base N-62. The surfactant may be applied by any conventional means, such as spraying, printing, brush coating or similar techniques. The surfactant may be applied to the entire substrate or may be selectively applied to particular sections of the substrate, such as the medial section along the longitudinal centerline of the diaper, to provide greater wettability of such sections. The substrate may further include a lotion or treatment applied thereto that is configured to be transferred to the wearer's skin. Suitable compositions for application to the substrate are described in U.S. Pat. No. 6,149,934 that issued to Krzysik et al. on Nov. 21, 2000.

Exemplary approaches by which a disposable substrate may be prepared are disclosed in U.S. Pat. No. 6,806,213 B2 and U.S. Publication Number 2003/0119395 A1, both entitled “Disposable Wash Cloth and Method of Using,” to JoAnn Adele Brooks, both of which are hereby incorporated in their entirety in a manner consistent herewith (said documents also disclose a number of ingredients, including fragrances and surfactants, that may be used as part of the cleaning composition).

Additional color-changing systems that may be deposited or associated with a substrate include redox and pH systems. Such systems are disclosed in co-pending U.S. application number 2005/0049157 A1, entitled “Single Phase Color Change Agents” to MacDonald et al. As stated above, this application is incorporated by reference in its entirety in a manner consistent herewith.

Note, too, that a cleaning composition comprising one or more thermochromic ingredients may be employed in a substrate that dissolves. One example of such a substrate is disclosed in U.S. Patent Publication Number 2004/0048759 A1, entitled “Extruded Cleansing Product,” to Brendon Ribble, et al., which is hereby incorporated by reference in its entirety in a manner consistent herewith.

Representative Signals Conveyed by a Color Change in a Composition Comprising One or More Thermochromic Ingredients.

In some versions of the invention, a color change effected by one or more thermo-chromic ingredients in a cleaning composition serves to indicate to the user that the correct hand washing period has elapsed and rinsing can commence. It is well documented in the literature that most people (both adults and especially children) do not wash their hands for a sufficient amount of time to properly ensure cleansing has occurred. The Centers for Disease Control and Prevention (“CDC”) has issued hand washing guidelines listing the correct time period (see Table 5).

TABLE 5
TYPES of HAND CARE

| | Purpose | Method |
|---|---|---|
| Handwash | To remove soil and | Soap for 10-15 seconds |
| | transient microorganisms | |
| Hand Antisepsis | To remove and destroy | Antimicrobial soap for 10-15 secs |
| | transient microorganisms | (Health Care) |
| Surgical Hands | To destroy transient microorganisms | Antimicrobial soap with brush |
| | and reduce resident flora. | for 120 seconds. |

The amount of time needed to clean the skin or a surface has been researched extensively. The Association for Professionals in Infection Control and Epidemiology (APIC) Guideline for Hand Washing and Hand Antisepsis in Health-Care Settings (1995) (Table 1), recommends a wash time of 10-15 seconds with soap or detergent for routine hand washing for general purposes. The APIC recommends an antimicrobial soap or detergent or alcohol-based rub wash for 10-15 seconds to remove or destroy transient micro-organisms in for example, nursing and food preparation applications. The APIC further recommends an antimicrobial soap or detergent with brushing for at least 120 seconds for surgical applications. The US Centers for Disease Control and Prevention (CDC) recommends up to 5 minutes of hand cleaning for surgical applications. Clearly, the length of time spent washing the hands can have a great effect on eradication of microbes. Thus there is a need for a cleaning formulation that will enable the user to judge how long he has washed his hands in order to comply with the guidelines.

Proper hand washing habits are important for children also. Children in particular need guidance in determining the appropriate amount of time for which hand washing should be performed. This guidance is generally given by parents or other caregivers and, while important, is not omni-present. In addition to parental guidance, various other mechanisms have been used to encourage longer hand washing times in children. Soaps have been formulated as foams, for example, to increase the enjoyment children find in hand washing and thus to increase the amount of time children spend in washing. Fragrances have also been used to make the hand washing experience more enjoyable. Accordingly, different versions of the present invention may be used to convey information, or provide a signal, regarding the duration of use of the cleaning composition employing one or more thermochromic ingredients. Some versions of the invention are directed to the corresponding method of developing hygiene habits in children by, for example, dispensing or positioning in the hands of a user, in this case a child, a color-changing cleaning composition comprising a thermochromic ingredient; and using the composition for a time sufficient to effect a color change detectable by said user (in this case, by a child).

In other versions of the invention, the color change or color changes effected by the cleaning composition signifies information about the temperature or temperature range of a material with which the cleaning composition has been brought into contact. As noted earlier, a person's perception of temperature through touch may be somewhat crude. Often a caregiver attempts to determine whether or not bath water is at an acceptable temperature for an infant or child by dipping his or her hand or fingers into the water. In some versions of the present invention, a cleaning composition (e.g., in the form of a composition comprising one or more thermochromic ingredients to be introduced to the bath water; or in the form of a substrate including a cleaning composition comprising one or more thermochromic ingredients) may be used to provide information to the caregiver regarding the bath-water temperature. A thermochromic ingredient, or ingredients, may be selected for the composition that effect a color change at some temperature or temperature range proximate to a recommended bath-water temperature for children and/or infants. In another version of the invention, one thermochromic ingredient could be selected that effects a color change at a temperature or temperature range proximate to a recommended bath-water temperature, and a second thermochromic ingredient could be selected that effects a different color change at a temperature proximate to a maximum bath-water temperature that may be injurious to an infant or child. In this way a caregiver using a cleansing composition of the present invention, or a substrate including a cleaning composition (i.e., a substrate of the present invention), could help to ensure the safety and/or comfort of his or her infant or child. Note that the preceding version of the invention may be used in other settings with persons in need of assistance or care (e.g., adults in a nursing home; people in a hospital; etc.). i.e., in any instance where a caregiver is providing cleansing assistance in some manner, the present invention may be used to help ensure the safety and/or comfort of the person being assisted. Furthermore, in such contexts, the present invention may be used to ensure the effective cleansing of such persons being assisted by a caregiver.

In other versions of the invention, compositions comprising one or more thermochromic ingredients may be used to help signify or convey a psychological or mental state in the mind of the user. For example, a cleansing composition comprising one or more thermochromic ingredients may be placed in a product adapted for use in a bath. The composition would change to one or more colors depending on the temperature or temperature range of the bath water. The color or colors may be selected to correspond to a given mental state, psychological state, or state of well being, e.g., peace, harmony, energy, freshness, spirituality, sensuality, relaxation, etc. Furthermore, fragrances or aromas may be selected and combined with the composition to help further induce such mental state, psychological state, or state of well being.

Examples of fragrant compounds include, but are not limited to, perfumes, essences, fragrance oils, and so forth. As is known in the art, many essential oils and other natural plant derivatives contain large percentages of highly volatile scents. In this regard, numerous essential oils, essences, and scented concentrates are commonly available from companies in the fragrance and food businesses. Exemplary oils and extracts include, but are not limited to, those derived from the following plants: almond, amyris, anise, armoise, bergamot, cabreuva, calendula, canaga, cedar, chamomile, coconut, eucalyptus, fennel, jasmine, juniper, lavender, lemon, orange, palm, peppermint, quassia, rosemary, thyme, and so forth.

Fragrances may have colors associated with the fragrance. For example, the color lavender or purple is often associated with a lavender scent; the color yellow is often associated with a chamomile scent, a daffodil and the like; the color red is often associated with a rose scent and the like; and the color green is often associated with the scents of aloe, wintergreen and the like. Accordingly, the color or colors effected by a composition of the present invention may be selected to create an association in the mind of the user between the fragrance(s) and the effected color change(s). Other color and scent combinations may be utilized in the present invention.

As stated above, the color change or changes effected by a composition of the present invention, along with any optional scents or fragrances, can be used to help induce a desired psychological or mental state, including, for example, states of relaxation, peace, sensuality, energy, visualization of specific times and/or places, spirituality, visualization of various natural settings, etc.

The manufacturer of said composition may fashion messages, statements, or copy to be transmitted to a purchaser, consumer, or user of said composition. Such messages, statements, or copy may be fashioned to help facilitate or establish an association in the mind of a user of the composition between the composition, or use thereof, and one or more mental states, psychological states, or states of well being. The communication, statements, or copy may include various alphanumeric strings, including, for example: relax, peace, energy, energize, sex, sensuality, sensual, spirit, spiritual, clean, fresh, mountain, country, zest, sea, sky, or some combination thereof. These alphanumeric strings may be used either alone, adjacent to, or in combination with, other alphanumeric strings. The communication, statements, message, or copy could take the form of (i.e., be embodied in a medium such as) a newspaper advertisement, a television advertisement, a radio or other audio advertisement, items mailed directly to addressees, items emailed to addresses, Internet Web pages or other such postings, free standing inserts, coupons, various promotions (e.g., trade promotions), co-promotions with other companies, copy and the like, boxes and packages containing the product (in this case a personal care or cleaning composition), and other such forms of disseminating information to consumers or potential consumers. Other exemplary versions of such communications, statements, messages, and/or copy may be found in, for example, U.S. Pat. Nos. 6,612,846 and 6,896,521, both entitled “Method for Displaying Toilet Training Materials and Display Kiosk Using Same”; co-pending U.S. application Ser. No. 10/831476, entitled “Method of Enunciating a Pre-Recorded Message Related to Toilet Training in Response to a Contact”; co-pending U.S. application Ser. No. 10/956763, entitled “Method of Manufacturing and Method of Marketing Gender-Specific Absorbent Articles Having Liquid-Handling Properties Tailored to Each Gender”; each of which is incorporated by reference in their entirety in a manner consistent herewith. It should be noted that when associating statements, copy, messages, or other communications with a package (e.g., by printing text, images, symbols, graphics, color(s), or the like on the package; or by placing printed instructions in the package; or by associating or attaching such instructions, a coupon, or other materials to the package; or the like) containing cleaning compositions of the present invention, the materials of construction of said package may be selected to reduce, impede, or eliminate the passage of sunlight, light, or ultraviolet radiation through at least a portion of the package. As noted above, one purpose for microencapsulating thermochromic ingredients is to protect the ingredients from ultraviolet radiation. Accordingly, packages containing cleaning compositions comprising thermochromic ingredients susceptible to damage by light, sunlight, and/or ultraviolet radiation may be protected by selecting materials for constructing the package that also impede or eliminate the passage of such forms of electromagnetic radiation.

Furthermore, any of the approaches described in the preceding paragraphs may be used to convey or transmit a message, copy, statements, and the like, to consumers regarding use of cleaning compositions comprising thermochromic ingredients for use in the training of children in good hygiene habits; for use in establishing that cleaning or washing has been conducted for specific and/or effective durations of time; for use in establishing that the temperature of a material with which the cleaning composition has been brought into contact is comfortable and safe, and/or not injurious; and the like.

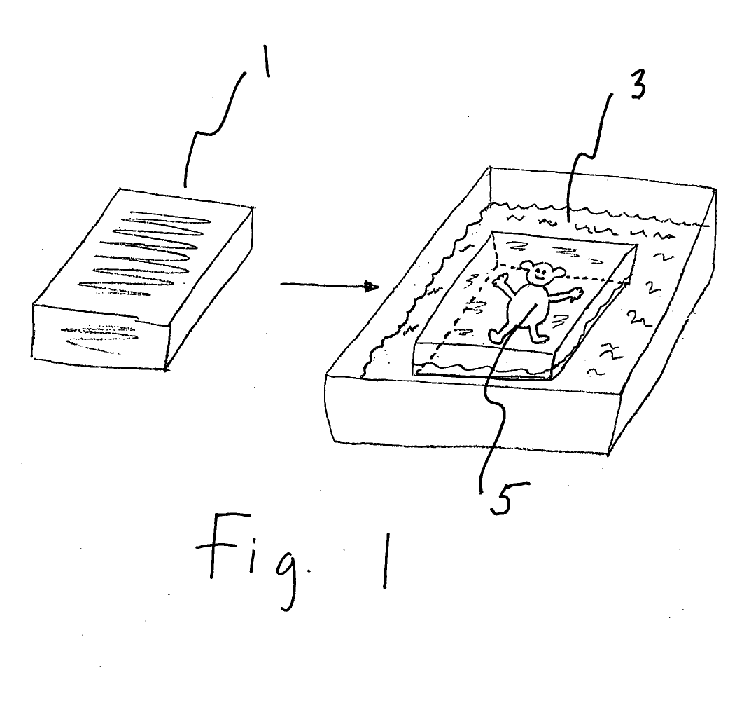

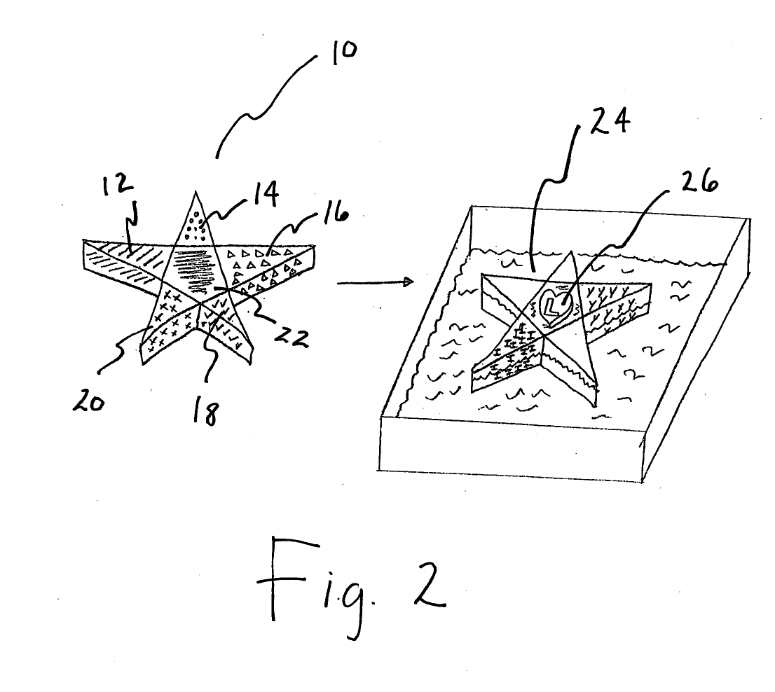

In other versions of the invention, the color change or changes effected by a personal-care or cleaning composition comprising one or more thermochromic ingredients may be used to help create a “play” or “entertainment” aspect to use of said composition. In some exemplary embodiments, the “play” or “entertainment” value is obtained solely by the color change, or color changes, effected by use of the composition having one or more thermochromic ingredients. As described in the Examples section below, bar soaps may be made into shapes (e.g., animals, etc.), with the soap effecting one or more color changes in use. Furthermore, the soap can be manufactured to contain one or more novelty items (e.g., a plastic toy figure, etc.) that are revealed and ultimately accessible only after the soap is systematically used. In FIG. 1, for example, a representative embodiment is depicted in which a bar of soap 1 comprises one or more thermochromic ingredients and a novelty item. On placement of the bar in warm water 3, the thermochromic ingredient, or some portion of a plurality of thermochromic ingredients, effect a color change from a colored state to a colorless state, such that the bar becomes transparent in a region proximate to the embedded novelty item 5. In another representative embodiment, a shaped bar of soap 10 comprises a plurality of regions 12, 14, 16, 18, 20, and 22. One or more of these regions includes one or more thermochromic ingredients. On placement of the shaped bar in warm water 24, thermochromic ingredients effect one or more color changes in one or more of said regions (optionally this will occur in sequence and/or time, if the selected thermochromic ingredients effect color changes at different temperatures, for example). Also, one or more regions may, as depicted in the central region 22 of FIG. 2, include a thermochromic ingredient that changes from a colored state to a colorless state, thereby revealing a novelty item 26.

The preceding paragraphs give examples of information conveyed or signified by a color change, or color changes, effected in a composition of the present invention, or substrates of the present invention. But other signals effected by a color change, or color changes, are possible and encompassed by the present invention.

### EXAMPLES

### Example 1

### Liquid Soap Comprising One or More Thermochromic Ingredients

A hand cleanser, Kimberly-Clark Professional Antibacterial Clear Skin Cleanser (listed ingredients include water, sodium laureth sulfate, citric acid, cocamidopropylamine oxide, lauryl glocoside, sodium chloride, PEG-7, glyceryl cocoate, hexyl glycol, DMDM hydanton, with an active ingredient, 0.25% wt/wt Triclosan), was obtained from Kimberly-Clark Corporation, a business having offices in San Antonio, Tex. Various thermochromic ingredients were obtained from Color Change Corporation, a company having offices in Streamwood, Ill.; and Chromatic Technologies Incorporated, a business having offices in Colorado Springs, Colo. The ingredients obtained from Color Change Corporation are identified above in Table 1. The ingredients obtained from Chromatic Technologies Incorporated are identified above in Tables 2 and 3. Initially we combined the ingredients with the K-C Professional Antibacterial Clear Skin Cleanser to evaluate the ease with which the materials could be mixed. We found that the various thermochromic ingredients were easily mixed with the hand cleaner, and gave intensely colored liquids. For the initial evaluation a series of skin cleanser formulations were prepared with increasing percent solids (%) of the thermochromic dyes to determine the dye concentration which would give a deep, readily perceivable (to a user or caregiver) color to the skin cleanser at room temperature, but also gave a vivid (i.e., readily perceivable by a user or caregiver) color change when placed on a hand and rubbed on the skin.

We prepared 10-gram cleaning compositions having concentrations of thermochromic ingredients ranging from 0.1 to 1.0% wt/wt (i.e., weight of added thermochromic ingredient divided by the weight of the above-identified KC Professional skin cleanser prior to addition of the thermochromic ingredient). The leuco dye powders studied were those denominated as Red 29C (corresponding to an ingredient that proceeds from a “Cold Color” of red to a colorless “Warm Color” at a transition temperature of 29 degrees Celsius), Red 31 C (corresponding to an ingredient that proceeds from a “Cold Color” of red to a colorless “Warm Color” at a transition temperature of 31 degrees Celsius), and Blue 31 C (corresponding to an ingredient that proceeds from a “Cold Color” of blue to a colorless “Warm Color” at a transition temperature of 31 degrees Celsius) from Color Change Corporation identified in Table 1 above. The powders (i.e., thermochromic ingredients) were mixed with the skin cleaner in glass vials (2 oz size) with a magnetic stir bar on a hotplate-stirrer (Corning stirrer/hot plate model PC-620, Midland Mich.) at ambient temperature. The mixture was stirred for 10 minutes, at a setting of 7, to ensure complete distribution of the powder (i.e., the microencapsulated thermochromic ingredient) throughout the liquid skin cleaner.

Thermochromic ingredient concentrations of 1%, 0.5%, 0.4%, 0.35%, 0.2%, and 0.1% wt/wt mixtures of the KC Professional skin cleanser and thermochromic ingredient were made for each of the three thermochromic ingredients identified above (i.e., for each of the thermochromic ingredients Red 29C, Red 31C and Blue 31C available from Color Change Corp.—as identified in Table 1 above). A 1-gram aliquot of each mixture was placed on the palm of a user's dry hand, and rubbed on the skin in an approximately circular area having a 5-centimeter diameter. The color change was then observed and a visual determination was made as to the vividness and completeness of the color transition determined by eye (i.e., the extent to which a user and/or observer could readily perceive the color the liquid comprising a thermochromic ingredient in its initial state; and after a color change was effected by the thermochromic ingredient). For this initial investigation, it was preliminarily determined that, for the three evaluated thermochromic ingredients, concentrations ranging from about 0.4% wt/wt to about 1% wt/wt provided for an initial color, and color change, that were readily perceivable by participants in the test (and would likely be readily perceivable by users of a personal care or cleaning composition employing these thermochromic ingredients at these concentrations).

Next approximately 1 gram of each of the mixtures having a thermochromic-ingredient concentration of 0.4% wt/wt or greater was placed on the pre-wetted palm of a user's hand and hand-washing action was commenced. The temperature of the water used was between 30 and 34 degrees Celsius. This series of thermochromic ingredient/cleanser mixtures were screened for vividness of the color change along with the time taken for the color to be discharged and give white lather. At this point, the hands were rinsed until all the lather was rinsed off. No color was observed to remain on the hands, nor did any staining on the hands occur. It was determined in this set of evaluations that the samples with the higher (1.0% wt/wt) concentration of thermochromic ingredient gave the most vivid color change. The color change typically occurred approximately ten to twenty seconds after the commencement of hand washing. Again, as noted above, the terms “vivid” or “vividness” with respect to a color change denote a color change that was readily detectable by a user of the cleaning composition incorporating a thermochromic ingredient.

To further evaluate the vividness of the color change effected by cleaning compositions comprising one or more thermochromic ingredients during handwashing, and also to show that the color change was not due to the dilution of color due to the formation of lather, a 200 gram sample of the K-C Professional liquid skin cleanser was prepared with substantially non-color-changing dyes/pigments (for this experiment, blue and red soap dyes, available from Life of the Party, a business having offices in North Brunswick, N.J.). The substantially non-color changing pigment (39 drops of blue and 13 drops of red) was added to the skin cleanser and the mixture stirred by hand with a spatula to generate a liquid skin cleanser that was of the same color and intensity as the blue 31C thermochromic formulation. When 1 gram of this substantially non-color-changing formulation was placed on a pre-wet palm of the hand and hand washing carried out, it was clearly seen that the blue color was diluted down only a small fraction; however the lather was still a readily detectable blue color which did not decolorize or become white even after hand-washing for several minutes. This experiment helped establish the efficacy of a thermochromic ingredient in effecting a color change when employed in a cleaning or personal-care composition.

Ten grams of a purple-colored skin cleanser composition was then prepared by placing 0.5% wt/wt of the Red 29C powder and 0.5% wt/wt of the 29C blue powder (both thermochromic ingredients are available from Color Change Corporation and are identified in Table 1 above) together into the K-C Professional skin cleanser and mixing for 10 minutes using a magnetic stir bar and stirrer as described previously. This purple formulation was evaluated in a handwashing experiment where 1 gram of the mixture was placed on the palm of the pre-wetted hand with hand-washing action then commencing. The purple liquid was converted into purple lather which turned white after approximately 15 seconds of hand-washing action. These mixtures can turn colorless at a sharp temperature transition or move from one color to another followed by a colorless state by selecting two or more dyes with different temperature transitions, as discussed generally in the Description section above.

In the experiments described in the preceding paragraphs, we qualitatively and preliminarily determined that the optimum lowest concentration for the specific ingredients and hand cleanser evaluated above was about 0.4% wt/wt, because the user could easily perceive the color in the unused liquid soap, and because the cleaning composition transformed to a colorless liquid on hand washing under the general conditions identified above (with the color change readily detectable by the user). We also qualitatively and preliminarily determined that an optimal concentration for the specific ingredients and hand cleanser evaluated above was about 1% wt/wt, for the same reasons and under the general conditions identified above. Of course other concentrations may be used, depending on: the information sought to be conveyed to a user; the identity of the selected thermochromic ingredients; the composition that employs said ingredients; and the context within which the composition employing one or more thermochromic ingredients will be used.

### Example 2

### Liquid Soap Comprising A Plurality Thermochromic Ingredients

A hand cleanser, Kimberly-Clark Professional Antibacterial Clear Skin Cleanser, was obtained from Kimberly-Clark Corporation, a business having offices in San Antonio, Tex. We prepared various combinations of the K-C Professional hand cleanser and combinations of two thermochromic ingredients, in this case ingredients obtained from Color Change Corporation. These cleaning compositions provided for a change from one color to a second color, and then from the second color to a colorless state (or a white color if foam was present) during the hand-washing period of use. For these experiments, a thermochromic ingredient effecting a color change at 29 degrees Celsius was mixed with a thermochromic ingredient effecting a color change at 33 degrees Celsius to achieve multiple color transitions. The colors were selected based on primary color mixing where the mixture of colors generated an initial color which changed to the second color when the lower-temperature thermochromic dye (i.e., the thermochromic ingredient effecting a color change at a temperature lower than the temperature at which the other thermochromic ingredient effected a color change) turned colorless. For these experiments, a 0.5% wt/wt of each dye powder was added to the liquid (K-C Professional skin cleanser) and stirred to give the prototype formulations. Table 6 lists the prepared examples of cleaning compositions exhibiting multiple color transitions. One gram of a cleaning composition comprising two thermochromic ingredients was placed on a pre-wet palm of the hand and hand-washing action was then commenced. The time to change from one color to the second color was measured and the hand-washing action continued until the second color transition/change occurred and the time noted for the second transition. The hands were then rinsed thoroughly and checked for any residual color. Each experiment was run in duplicate.

TABLE 6
Multiple Color Changing Cleaning Composition

| Initial Color | | |
|---|---|---|
| (Color of mixture, | | Finish Color |
| followed by colors of | | Signals |
| individual thermochromic | Intermediate Color | completion |
| ingredients) | (Time, seconds) | (Time, seconds) |
| BLACK | Blue | Colorless |
| 29C Black (CCC) | 3 seconds, 5 seconds | 12 seconds, |
| 33C Blue (CCC) | | 16 seconds |
| PURPLE | Red | Colorless |
| 29C Blue (CCC) | 5seconds, 4 seconds | 15 seconds, |
| 33C Red (CCC) | | 12 seconds |
| BROWN* | Green | Blue |
| 29C Red (CCC) | (the red drops out leaving | 12 seconds, |
| 33C Yellow (CCC) | blue plus yellow | 14 seconds |
| FDC Blue 1 | which gives green) | |
| | 4 seconds, 5 seconds | |

*For this formulation, 150 ml of hand soap formulation; 0.5% wt/wt of both red and yellow thermochromic dyes followed by 10 mg of FD&C blue No. 1 (Noveon Inc., Cleveland, OH). CCC denotes that the Leuco powders from Color Change Corporation were used as listed in Table 1.

As can be seen in Table 6, a variety of multiple color-changing cleaning compositions of the present invention may be made by combining a plurality of thermochromic ingredients. Furthermore, a substantially non-changing color component may be added to modify the colors exhibited by the cleaning composition comprising thermochromic ingredients.

### Example 3

### Bar Soap Cleaning Composition Comprising One or More Thermochromic Ingredients

Color changing bar soaps were prepared to show that bar soaps could change color a) during hand-washing use; b) to serve to alert the user that the water is too hot; c) to undergo a series of multiple color changes for fun and play; d) to demonstrate a fun shaped soap which comprises multiple color sections e.g. legs, heads, arms, faces. The color changing bar soap prototypes were prepared by adding thermochromic ingredients into melted glycerin soap (Neutrogena (listed ingredients include TEA-stearate, triethanolamine, sodium tallowate, glycerin, purified water, sodium cocoate, sodium ricinoleate, TEA-oleate, cocamide DEA, tocophenol), Neutrogena Corporation, Los Angeles Calif.; or Clearly Natural transparent facial bar (listed ingredients include sodium cocoyl, isethionate, stearic acid, coconut acid, sodium tallowate, sodium isethionate, water, sodium stearate, cocamidopropyl betaine, sodium cocoate, fragrance, sodium chloride, tetra sodium EDTA, BHT, titanium dioxide); Clearly natural, Petaluma Calif.). The glycerin soap (100 gram batches were used for each preparation) was cut up or grated into small pieces and placed in a double-boiler type pot. Water was used in the larger pot and heated to boiling to effect indirect heating of the soap. Ethanol (9 ml per 100 gram of soap) was added to the soap pieces in the smaller inner container. The soap slowly dissolved to form a clear liquid, which was cooled to 50 degrees Celsius before adding the 29C, 31 C or 33C thermochromic powder (1% wt/wt of thermochromic ingredients obtained from Color Change Corporation; i.e., the blue, red, yellow and black ingredients identified in Table 1 above). The mixture was stirred, by hand, for 4 minutes with a spatula, to disperse the thermochromic ingredient uniformly into the soap which was then poured into molds and allowed to cool to ambient temperature. When the soap was placed in water at a temperature of 40 degrees Celsius the bar slowly turned colorless and transparent. When it was used to wash hands the soap generated colored lather which became white after a period of hand washing of about 10-15 seconds. The method used to evaluate the bar soap is described in the following paragraph.

The hands were pre-wet by placing them under a faucet where the water temperature had been adjusted to a temperature of 34 degrees Celsius. Next the bar soap was placed between the hands and rubbed to generate lather for 5 seconds. The bar soap was then placed back on a holder and handwashing continued by rubbing the hands together. The initial color of the soap and therefore lather was observed to discharge over 12-15 seconds resulting in a pure white lather. The time was noted at this point of the color change. The results show that the 29C thermochromic bar soap lathers generally turned white faster, in the range of approximately 8-12 seconds. The 31 C and 33C thermochromic bar soap lathers were found to remain colored longer, giving a lather color change in the range of 12-20 seconds.

In addition, pluralities of thermochromic ingredients available from Color Change Corporation (0.5% wt/wt of each color) were also used to make bar soaps that would undergo multiple color changes as a bar comprising the ingredients was warmed in water, or lather from the bar/soap was used to wash hands. Additional novelty bar/soaps were prepared using shaped molds (e.g. animals, people, trains etc). Some shaped bars were prepared with one thermochromic ingredient, while others were prepared such that different parts of the shape or object had different thermochromic ingredients/colors. This allowed visually attractive objects to be made where certain parts changed color at one temperature and other parts changed color at higher temperatures. In one example, a green-colored thermochromic bar soap was prepared. One hundred grams of transparent glycerin soap was diced into 5 mm×5 mm pieces and placed into the double boiler, containing water on the outside beaker. To this was added 9 ml of ethanol and the system heated till the water was boiling. The soap slowly melted and dissolved to form a transparent colorless liquid. The inner beaker was then removed from the water-containing outer vessel and the hot soap allowed to cool down to 50 degrees Celsius, as measured by a thermometer, and then 0.5 gram of a 33C blue thermochromic ingredient and 0.5 gram of a 31C yellow thermochromic ingredient, both available from Color Change Corporation (see Table 1 above), were added to the liquid. The thermochromic ingredients were dispersed into the liquid by mixing the formulation using a spatula. The mixed formulation was then poured into a non-stick muffin pan (obtained from a Kroger grocery store) and allowed to cool and solidify (which occurred after approximately 5 hours). Soaps bars each weighing 15 gram were prepared. To demonstrate the color change properties the bar soaps were tested as follows. The hands were pre-wet under a running faucet, where the water temperature had been adjusted to 34 degrees Celsius. The bar of colored soap was then placed between the hands and rubbed for 5 seconds to generate sufficient lather. The bar was then placed back in the container and the hand-washing continued. The initial color of the lather was green which was observed to change to blue within 4-5 seconds due to the yellow thermochromic ingredient decolorizing (i.e., changing from a yellow color to a colorless state). On continued hand washing the lather turned white due to the blue thermochromic ingredient turning colorless, which occurred after a further 8-10 seconds. At this point the hands were rinsed thoroughly to remove the lather.

### Example 4

### Body Wash Cleaning Composition Comprising One or More Thermochromic Ingredients

Body wash formulations were converted into color changing cleaning compositions by using commercially available formulations. In this example, Dial 2-in-1 Body wash (The Dial Corporation, Scottsdale Ariz.; listed ingredients include water, sodium laureth sulfate, cocamido propyl betaine, sodium cocoamphoacetate, citric acid, iso stearamidopropyl morpholine lactate, glycol stearate, laureth-7, sodium chloride, disodium EDTA, propylene glycol, menthol) was selected as it was colorless and transparent. One percent wt/wt of blue 29C thermochromic ingredient available from Color Change Corporation; or two percent wt/wt of blue 29C thermochromic ingredient (50% solids) available from Chromatic Technologies Inc. (CTI, 50% solids, blue 29C) were added to 100 grams of the body wash and thoroughly mixed to disperse the thermochromic ingredient by using a magnetic stir bar on a stirrer hot plate for 10 minutes. The colored formulation was then evaluated in a manner similar to that of the skin cleanser described earlier. The evaluation was carried out by washing hands. Thus 1 gram of the formulation was placed on pre-wet hands (wetted with water at a temperature of 34 degrees Celsius) and hand-washing action commenced to produce a lather. The time taken for the color of the lather to turn pure white was noted. The evaluations determined that the color change occurred approximately 10 to 15 seconds after hand washing began.

### Example 5

### Water-Less Hand Sanitizer Comprising One or More Thermochromic Ingredients

A color-changing water-less hand sanitizer was prepared by adding a thermochromic ingredient (a blue powder that effects a color change from blue to colorless at about 29 degrees Celsius, available from Color Change Corporation) to Kimberly-Clark Professional moisturizing instant hand antiseptic (alcohol denatured 62%; listed ingredients include ethanol (62%wt/wt), water, glycerin, dimethicone, lauryl methacrylate/glycol dimethacrylate copolymer, carbomer, tocophenyl acetate, panthenol, hydroxypropylcellulose), a product available from Kimberly-Clark Corporation, a business having offices in San Antonio, Tex. The colored formulations were prepared by taking 10 ml of the instant antiseptic and adding the thermochromic ingredient to the liquid and stirring by hand with a spatula for 10 minutes to disperse the thermochromic ingredient. In this manner a series of colored formulations were prepared using the blue-to-colorless 29C leuco dye powder from Color Change Corporation. The series of samples had dye concentrations of 0.2% wt/wt, 0.5% wt/wt, and 1.0% wt/wt. The formulations were evaluated by placing 1 gram of the colored formulation on the dry palm of the hand and then spreading the liquid over all the hands by hand-washing action. Over a period of time the color was discharged. The time taken for this loss of color was determined. The 0.2% formulation took 3 seconds and 5 seconds respectively to decolorize. The 0.5% formulation took 10 seconds and 15 seconds to decolorize. The 1% formulation took 20 seconds and 25 seconds to decolorize. For the materials and conditions described above, the 0.5% wt/wt formulation was selected as the preferred concentration of the thermochromic ingredient as it gave a decolorization time deemed to be ideal to help ensure sanitization of the hands. Of course other concentrations may be used, depending on: the information sought to be conveyed to a user; the identity of the selected thermochromic ingredients; the composition that employs said ingredients; and the context within which the composition employing one or more thermochromic ingredients will be used.

### Example 6

### Foaming Cleaning Composition Comprising One or More Thermochromic Ingredients

A foaming-soap formulation sold under the name Dial Complete was obtained (available from The Dial Corporation, Scottsdale, Ariz.; listed ingredients in the formulation include water, ammonium lauryl sulfate, ammonium laureth sulfate, cocamide MEA, ammonium chloride, PEG-5 cocamide, cocamido-propyl betaine, hydroxypropylmethyl cellulose, tetrasodium EDTA, citric acid, and dimethicone copolyol). A color-changing foaming formulation was prepared by adding a thermochromic ingredient (blue 29C, available from Color Change Corporation and identified in Table 1 above) to the formulation at a concentration of 0.5% wt/wt. A second color-changing foaming formulation was prepared by placing 100 grams of the Dial Complete liquid into a beaker and adding 1 gram of the Chromatic Technologies Incorporated water slurry containing 50% solids of the blue 29C thermochromic dye (see Table 3 above). The resultant concentration of the thermochromic dye in this formulation was also 0.5% wt/wt. Each mixture was stirred on a hotplate/stirrer using a magnetic stir bar and stirred for 10 minutes. The liquid formulation mixtures were each poured back into the foaming containers in which Dial Complete was obtained. The formulations were tested by making one depression of the nozzle (this gives 0.5 gram of foam) onto the pre-wet palm of the hand. Hand-washing action was started and the time taken for the lather to turn white was measured. The lather was seen to change to a white color in the range of about 10-14 seconds.

A further study was conducted to determine the effect of higher temperature transition thermochromic dyes on the time taken for the lather to become white. Two additional foaming soap formulations were prepared in a similar fashion to the one described above, except that 31C and 33C blue thermochromic dyes, available from Color Change Corporation and identified in Table 1 above, were used. The study was conducted as described earlier and the results showed that the higher temperature thermochromic dyes result in the lather taking longer to become white. The results are shown as follows:

The Color Change Corp. blue 31 C thermochromic ingredient containing mixture took 16 and 18 seconds to become white.

The Color Change Corp. blue 33C thermochromic ingredient containing mixture took 24 and 26 seconds to become white.

It should also be noted that if the concentration of the Color Change Corp. blue 29C thermochromic ingredient containing mixture was increased to 2% wt/wt solids in the formulation, then the time taken for the lather to become white increased to 90 and 110 seconds. Thus adjusting the concentration of one or more thermochromic ingredients affects the duration of time after commencement of hand washing at which the color change occurs. And selecting the temperature at which the color change is effected can also affect the duration of time after commencement of hand washing at which the color change occurs. So, for example, thermochromic ingredient concentrations, or color-change transition temperatures, may be selected to produce different elapsed times at which a color change occurs. Appropriate times may be selected for compositions to be used by home users or food-preparation workers (e.g., the color change occurs approximately 10-15 seconds after initial use of the cleaning composition comprising one or more thermochromic ingredients); health-care workers (e.g., the color change occurs approximately 20 seconds after initial use of the cleaning composition comprising one or more thermochromic ingredients); and by surgeons (e.g., the color change occurs approximately 2 minutes after initial use of the cleaning composition comprising one or more thermochromic ingredients).

To further evaluate the vividness of the color change effected by cleaning compositions comprising one or more thermochromic ingredients during handwashing and also to show that the color change was not due to the dilution of color due to the formation of lather, a 212 ml sample of the Dial Complete was prepared with substantially non-color-changing dyes/pigments (for this experiment, blue and red soap dyes, available from Life of the Party, a business having offices in North Brunswick, N.J.). The substantially non-color changing pigment (36 drops of blue, 12 drops of red) was added to the foaming soap formulation and the mixture stirred by hand with a spatula to generate a foaming soap formulation that was of the same color and intensity as the blue 31C thermochromic formulation (from Color Change Corporation). When 0.5 gram of this substantially non-color-changing formulation was placed on a pre-wet palm of the hand and hand washing carried out, it was clearly seen that the blue color was diluted down only a small fraction; however the lather was still a readily detectable blue color which did not decolorize or become white even after hand-washing for several minutes.

### Example 7

### Substrates Containing a Cleaning Composition Comprising One or More Thermochromic Ingredients

A hand cleanser, Kimberly-Clark Professional Antibacterial Clear Skin Cleanser, was obtained from Kimberly-Clark Corporation, a business having offices in San Antonio, Tex. One percent wt/wt of blue 29C thermochromic ingredient available from Color Change Corporation; or two percent wt/wt of blue 29C thermochromic ingredient (50% solids) available from Chromatic Technologies Inc. (CTI, 50% solids, blue 29C) were added to 100-gram portions of the hand cleanser and thoroughly mixed to disperse the colorant by using a magnetic stir bar on a stirrer hot plate for 10 minutes. Nonwoven substrates were coated with each hand cleanser formulation using a dip-and-squeeze process to afford 100% wet weight add-on after coating and to generate colored substrates. These substrates were used as wet wipes with hand-washing action to produce a lather. The time taken for the color of the lather to turn pure white was noted. The evaluations determined that the color change occurred approximately 10 to 15 seconds after the hand washing action began.

We claim:

1. A color-changing cleaning composition comprising a thermochromic ingredient.

2. The composition of claim 1 further comprising a surfactant.

3. The composition of claim 2 further comprising an oil, detergent, emulsifier, film former, wax, perfume, preservative, emollient, solvent, thickener, humectant, chelating agent, stabilizer, pH adjuster, or some combination thereof.

4. The composition of claim 1 wherein the composition is adapted to convey information to a user, caregiver, or sensor by a color change effected by the thermochromic ingredient.

5. The composition of claim 4 wherein the concentration of the thermochromic ingredient is between about 0.4% wt/wt and about 2% wt/wt.

6. The composition of claim 4 wherein the concentration of the thermochromic ingredient is less than about 1% wt/wt.

7. The composition of claim 4 wherein the composition is in the form of a liquid, gel, or solid.

8. The composition of claim 4 wherein the composition is adapted to convey information signifying to a user, caregiver, or sensor that the composition is at a given temperature or temperature range.

9. The composition of claim 8 wherein the information signifies that the composition is at a temperature or temperature range between about 20 degrees Celsius and about 40 degrees Celsius.

10. The composition of claim 8 wherein the information signifies that the composition is a temperature or temperature range between about 25 degrees Celsius and about 35 degrees Celsius.

11. The composition of claim 4 wherein the composition is adapted to convey information signifying to a user, caregiver, or sensor that the temperature of a material with which the composition has been brought into contact is at a given temperature or temperature range.

12. The composition of claim 11 wherein the material is skin, a liquid, or non-living.

13. The composition of claim 4 wherein the composition is adapted to convey information signifying to a user, caregiver, or sensor that the time of contact between the composition and a material is of a given duration or range of durations.

14. The composition of claim 13 wherein the duration is about 10 seconds or less.

15. The composition of claim 13 wherein the duration is between about 10 seconds and about 25 seconds.

16. The composition of claim 13 wherein the duration is less than about 120 seconds.

17. The composition of claim 4 further comprising a substantially non-color-changing pigment.

18. The composition of claim 4 comprising a plurality of thermo-chromic ingredients.

19. The composition of claim 18 wherein the composition is adapted to effect a plurality of color changes.

20. The composition of claim 4 wherein the composition is a shaped bar of soap optionally containing a novelty item.

21. A package adapted to convey a message to a user of the composition of claim 4, the package comprising:
the composition of claim 4, wherein the composition is contained in said package; and
one or more statements characterizing the information to be signified to a user through use of the composition, wherein the statements are on, in, or attached to the package.

22. The package of claim 21 wherein the statements refer to promoting good hygiene in children.

23. The package of claim 21 wherein the composition is attached to a substrate contained in the package.

24. A package adapted to promote an association in the mind of a user between a composition contained in the package and a mental state, the package comprising:
the composition of claim 4, wherein the composition is contained in said package; and
one or more statements characterizing the mental state to be signified in the mind of a user by use of the composition, wherein the statements are on, in, or attached to the package.

25. The package of claim 24 wherein one or more statements comprise the following alphanumeric strings, either alone or in combination with other alphanumeric strings: relax, peace, energy, energize, sex, sensuality, sensual, spirit, spiritual, clean, fresh, mountain, country, zest, sea, sky, or some combination thereof.

26. The package of claim 24 further comprising a fragrance or aromatic ingredient.

27. The package of claim 26 wherein one or more statements establish an association between the fragrance or aromatic ingredient and one or more colors effected by the thermochromic ingredient, whether before or after a color change.

28. The package of claim 24 wherein the composition is attached to a substrate contained in the package.

29. The package of claim 24 or 21 wherein the package reduces or eliminates the transmittance of ultraviolet radiation, sunlight, or light through at least a portion of the package.

30. A message adapted to be communicated to consumers, wherein the message is based, in whole or in part, on information relating to a color-changing cleansing composition comprising a thermo-chromic ingredient, and wherein the message is contained in text, a symbol, a graphic, an image, and/or color, and wherein the message is embodied in a medium capable of being transmitted to consumers.

31. A substrate comprising:
a substrate; and
a color-changing cleaning composition comprising a thermochromic ingredient, wherein the composition is attached to said substrate.

32. The substrate of claim 31 wherein the composition is adapted to convey information to a user, caregiver, or sensor by a color change effected by the thermochromic ingredient.

33. The substrate of claim 32 wherein the concentration of the thermochromic ingredient in the composition is between about 0.4% wt/wt and about 2% wt/wt.

34. The substrate of claim 32 wherein the concentration of the thermochromic ingredient in the composition is less than about 1% wt/wt.

35. The substrate of claim 32 wherein the composition is adapted to convey information signifying to a user, caregiver, or sensor that the composition is at a given temperature or temperature range.

36. The substrate of claim 32 wherein the composition is adapted to convey information signifying to a user, caregiver, or sensor that the temperature of a material with which the composition has been brought into contact is at a given temperature or temperature range.

37. The substrate of claim 36 wherein the material is skin, liquid, or non-living.

38. The substrate of claim 32 wherein the composition is adapted to convey information signifying to a user, caregiver, or sensor that the time of contact between the composition and a material is of a given duration or range of durations.

39. The substrate of claim 38 wherein the duration is about 10 seconds or less.

40. The substrate of claim 38 wherein the duration is between about 10 seconds and about 25 seconds.

41. The substrate of claim 38 wherein the duration is less than about 120 seconds.

42. The substrate of claim 31 wherein the composition comprises a plurality of thermo-chromic ingredients.

43. A method of developing a hygiene habit in a user, the method comprising the steps of:
dispensing or positioning in the hands of a user a color-changing cleaning composition comprising a thermochromic ingredient; and
using the composition for a time sufficient to effect a color change detectable by said user.
